(19) United States
(12) Patent Application Publication
(10) Pub. No.: US 2011/0132823 A1
(43) Pub. Date: Jun. 9, 2011

(54) Stand alone rain water cllector

(76) Inventor: David Michael Brown, (US)

(21) Appl. No.: 12/630,738

(22) Filed: Dec. 3, 2009

(51) Int. Cl. C02F 1/00

(52) U.S. Cl. 210/170.03

(57) ABSTRACT

Stand alone structure for the sole purpose of collecting rainwater. Four radial arms attached to a trunk support a tarp. Rain falling on the tarp falls into four funnels at the four ends of the tarp. These funnels feed into piping and then in turn into a water tank. Water is then accessible from the valve of the tank.

### BACKGROUND

Water shortages in the United States and the world are not uncommon. Clean water sources are polluted and dwindling even though the majority of the planet is composed of water. However the planet's natural weather patterns involve the evaporation of water into the clouds, which eventually cool and fall back to the earth. This evaporation process does not operate on debris, salt, or fish semen or feces, thereby insuring that the water that falls back to the earth is cleaner than the water source it came from. Rainwater does sometimes contain microbes or air pollutants, but these hazards are offset by the mixture of chlorine with the rainwater. The Stand Alone Rainwater Collector system takes advantage of the planets natural water filtration system, concentrating and storing clean water that would otherwise be scattered and made inaccessible for human use.

### FIELD OF INVENTION

Rainwater collectors exist that collect rain from existing structures such as the roof of a house. The Stand Alone Rainwater Collector is unique in that it requires the construction of a new structure for collecting rain, but then in turn does not require a sophisticated water filtration system for purifying water collected from structures that normally serve another purpose.

### Problems

1. Potential for leaves, sticks and other debris to clog funnels or water tank.

2. Requires large space.

3. Works best in areas with large amounts of precipitation.

4. Air pollution.

5. Can be destroyed or mutilated by hazardous weather.

### Advantages

1. Low cost.

2. Provides service human beings will always need.

3. Has the potential to solve the global problem of water shortages.

4. For practical purposes space occupied shouldn't be more than the water tank and the trunk.

5. Creates a dialogue.

6. Is aesthetically pleasing.

### SUMMARY OF INVENTION

The Stand Alone Rainwater Collector works best in areas with large amounts of precipitation far from trees taller than ten feet. The creation of a new structure for the sole purpose of collecting rainwater bypasses the larger project of creating a water filtration system. The Stand Alone Rainwater Collector takes advantage of a free service provided by planet Earth and allows one of the most fundamental necessities of life to be marketed rather than squandered.

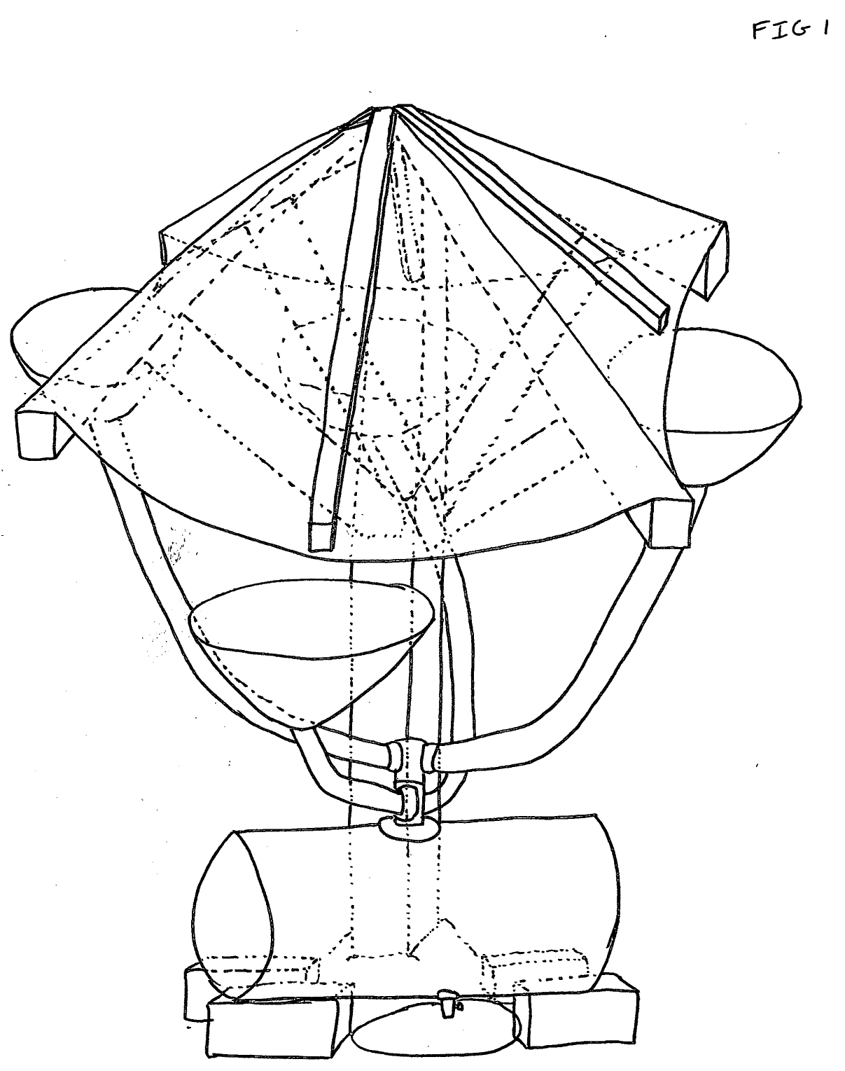

FIG. 1 is a diagram of the invention.

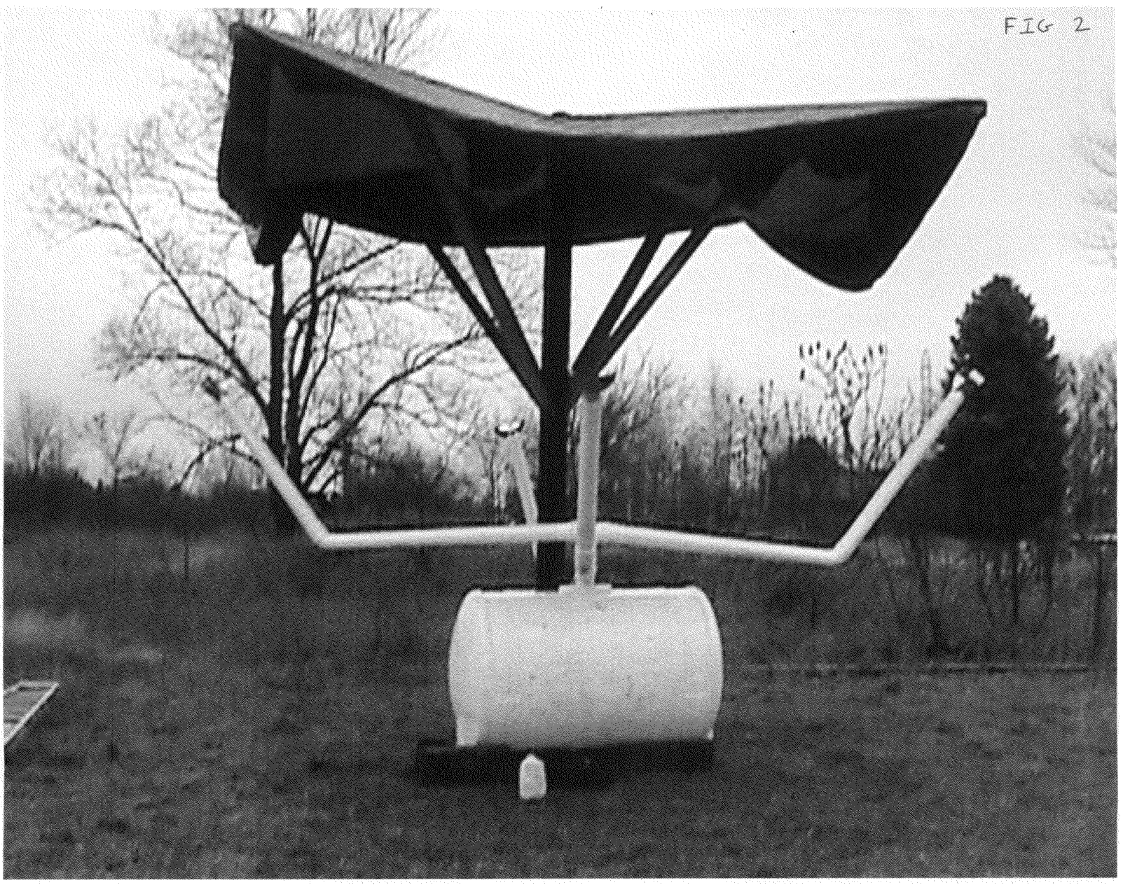

FIG. 2 is a photo of the entire invention.

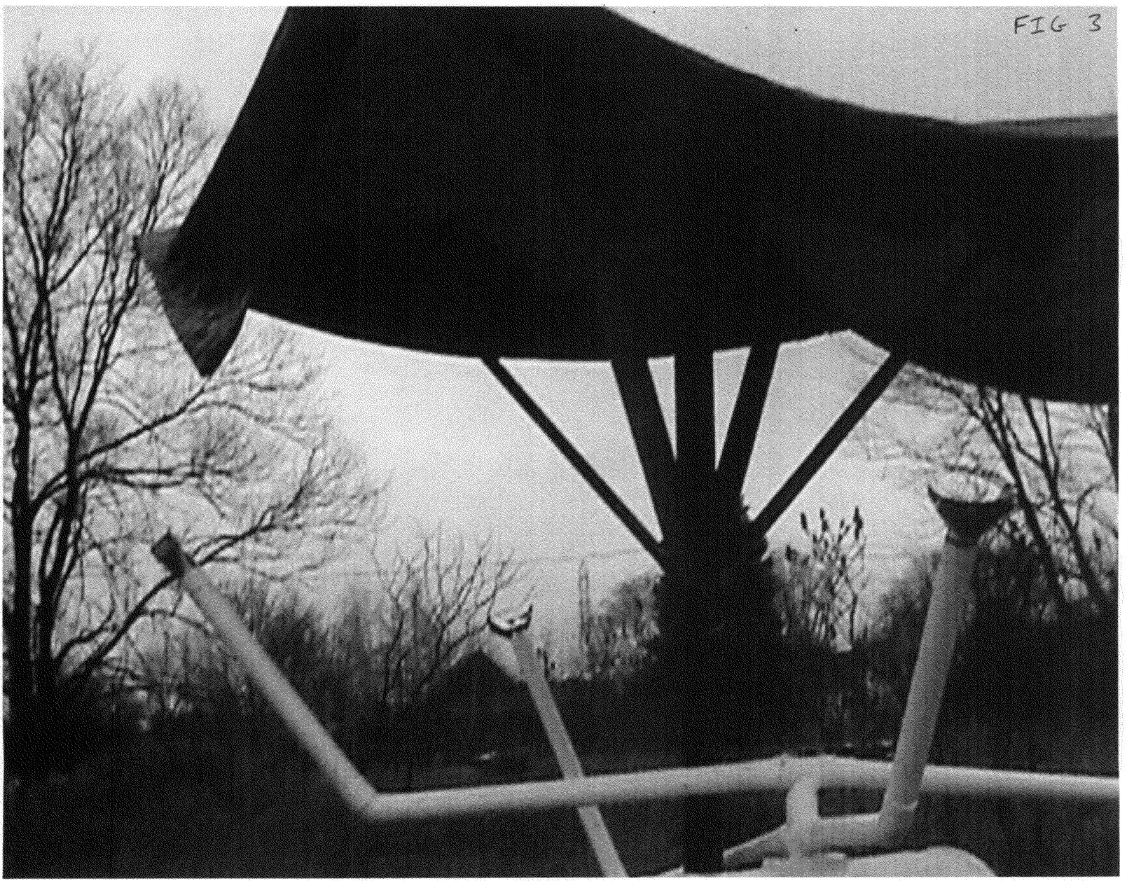

FIG. 3 is a photo of the tarp and pipes underneath.

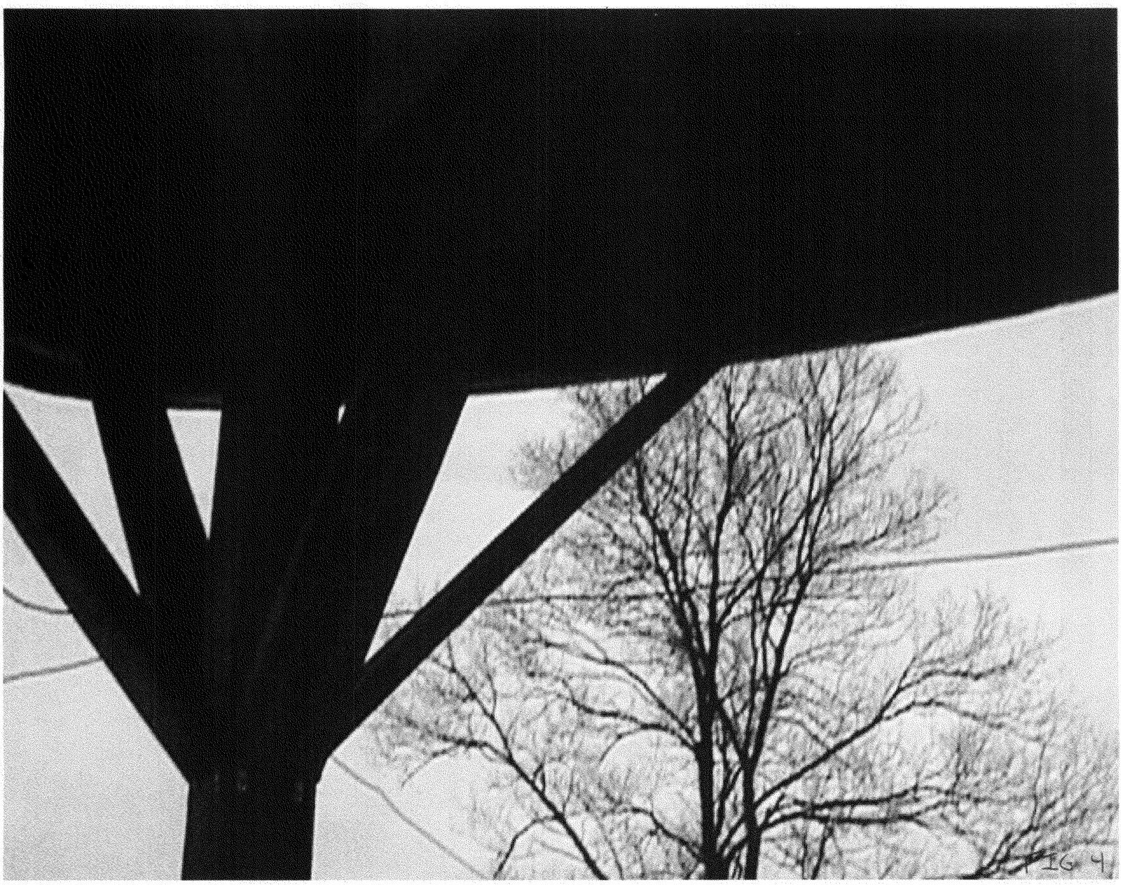

FIG. 4 is a photo of the supports for the tarp.

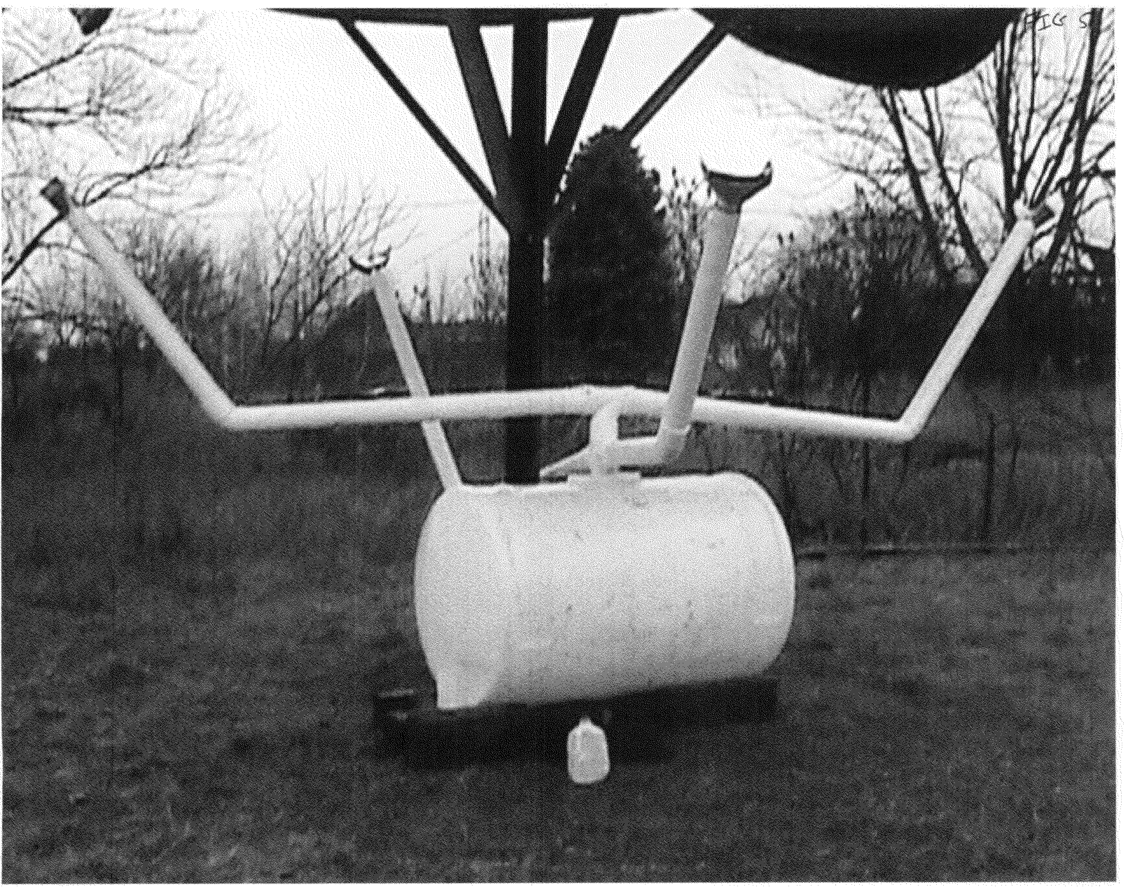

FIG. 5 is a photo of the pipes feeding into a tank.

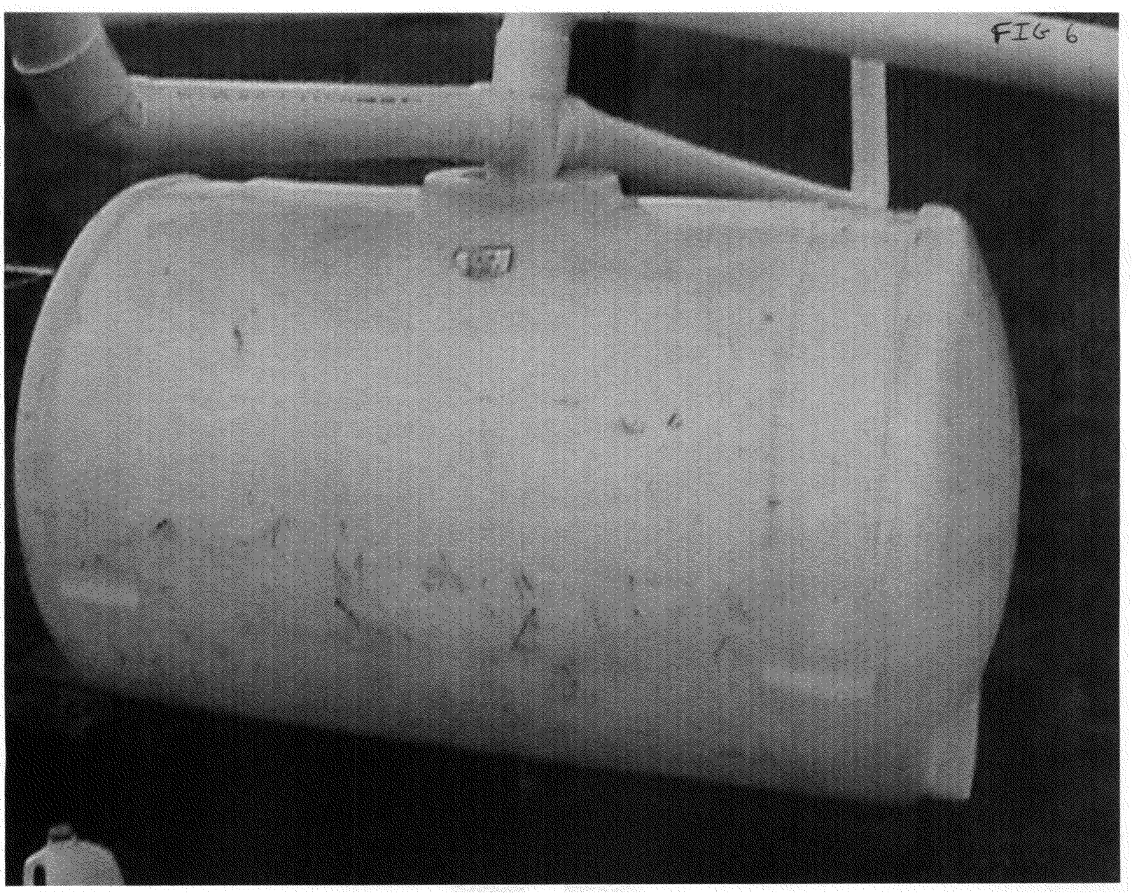

FIG. 6 is a photo of the tank itself.

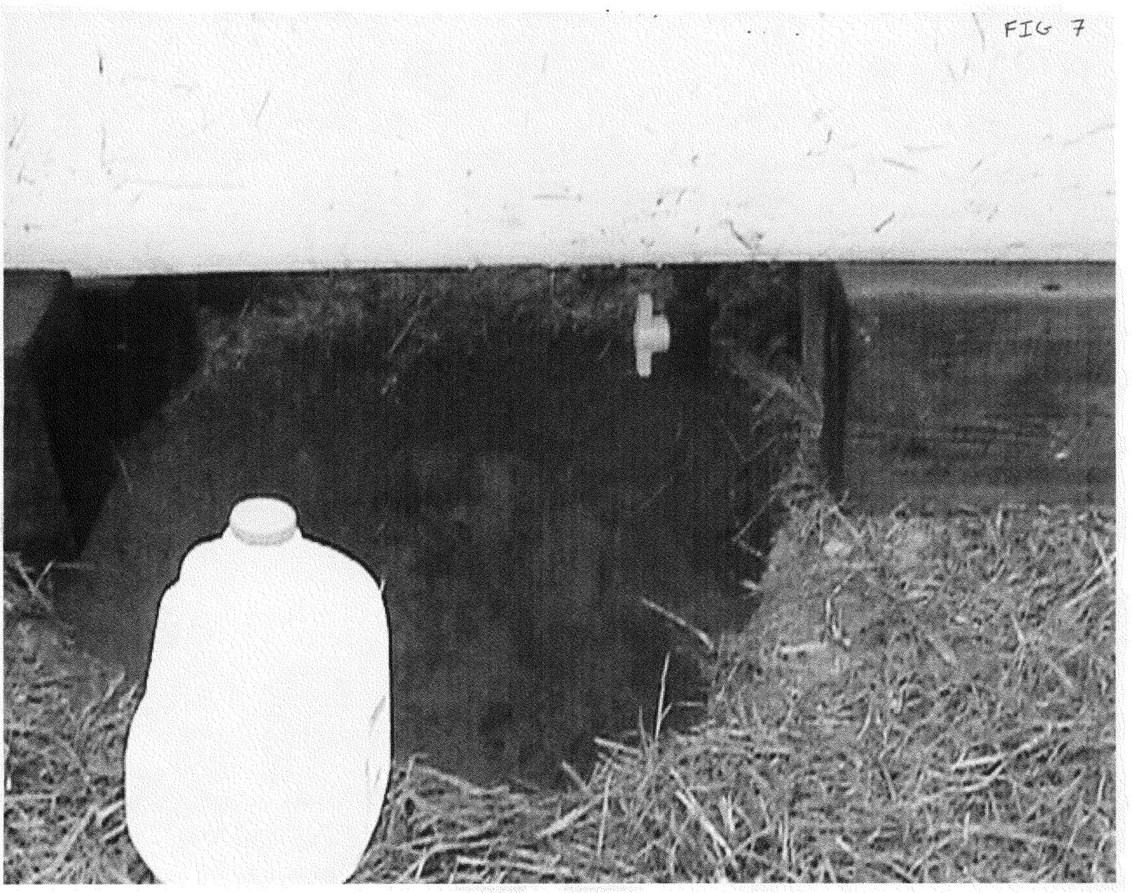

FIG. 7 is a photo of the valve, which keeps water stored when shut and allows water out when open, and the access area for water.

1. A structure for collecting rainwater wherein a tarp supported by four radial arms perpendicular to each other attached to the top of a single trunk collects rainwater, which falls into the dip made by the tarp between each arm and falls to the exterior of the tarp where it is collected by funnels, connected to piping, connected to a water tank.

2. The apparatus of claim 1 wherein the trunk is partially buried into the ground to support the structure.

3. The apparatus of claim 1 wherein the arms are attached towards or at the top of the trunk and radiate outwards.

5. The apparatus of claim 1 wherein the rainwater collects in the dip between each arm, concentrating the water at the edge of each side of the tarp.

6. The apparatus of claim 1 wherein the four funnels are positioned beneath these four points and each in turn feed into a pipe that connects to a water tank.

7. The apparatus of claim 1 wherein a valve connects to the water tank allowing water to be stored when closed and allowing water to be transferred to another receptacle when open.

8. The system of claim 1 wherein free water is collected, concentrated and stored for future use and/or consumption.
